(19) United States
(12) Patent Application Publication
(10) Pub. No.: US 2018/0268813 A1
(43) Pub. Date: Sep. 20, 2018

(54) MISSPEAK RESOLUTION IN NATURAL LANGUAGE UNDERSTANDING FOR A MAN-MACHINE INTERFACE

(71) Applicant: Intel IP Corporation, Santa Clara, CA (US)

(72) Inventors: Munir Nikolai Alexander Georges, Kehl (DE); Georg Stemmer, München (DE); Szymon Jessa, Gdansk (PL)

(73) Assignee: Intel IP Corporation, Santa Clara, CA (US)

(21) Appl. No.: 15/462,428

(22) Filed: Mar. 17, 2017

(51) Int. Cl. G10L 15/22; G10L 15/18; G10L 15/16; G10L 15/14; G10L 15/06

(52) U.S. Cl. CPC G10L 15/22; G10L 15/1815; G10L 2015/223; G10L 15/14; G10L 15/063; G10L 15/16

(57) ABSTRACT

Misspeaking is resolved in a natural language understanding system to interface with a machine. In one example, a user speech utterance is received. A sequence of classifiers is applied to words of the utterance to determine a meaning of the utterance. The meaning in interpreted as a command and the command is applied to a device for execution. The classifiers may include a first classifier to determine an intended function that is a subject of the utterance, a second classifier to determine words with properties that are related to the intended function, and a third classifier to select a property to apply to the function.

### FIELD

The present invention relates to the field of natural language understanding and, in particular, to resolving meanings of mistakes or misstatements in user statements.

### BACKGROUND

When speaking to a conversational computing or control system users often misspeak and use self-corrections, e.g. (1) “lights on in the living room, <ehm> no in the kitchen please” or (2) “increase temperature in bed-<ehm> bathroom”. A voice command or voice recognition system attempts to take these utterances and convert them into a command. Typically, the received audio is converted into a textual output or a set of phonemes in a speech recognizer. Any syntactical representation may be used for the described analysis. Common representations are given as a sequence of words or phonemes. The textual output will include all of the misspeaking, self-corrections or speech disfluencies. This is then converted into a unique structured semantic representation. The correct result for the above examples should be (1) “device=light, setting=on, room=kitchen” and (2) “device=temperature, setting=increase, room=bathroom”. However, the system may not understand what is meant by the misstatements.

When the voice command system fails to understand the user then the user becomes frustrated with the system. With some systems, the system asks the user to repeat the command or the system asks the user for clarification. Usually a user will make the statement correctly the second time. However, the interaction is not quick, easy, or intuitive for the user. As a result, voice command systems try to understand and correct misstatements, mispronunciations, and other common mistakes, just as people do.

In practical use, a user can misspeak and do self-corrections in a nearly unlimited number of ways. Speech disfluency can also happen at arbitrary times and outside of a predictable pattern. Speech recognizers use an explicit modelling of such cases, e.g. by writing grammars that include common mistakes and regular and proper ways of making corrections. The misspeaking, human corrections, and speech disfluency is programmed explicitly into the system with known solutions that allow the system to parse the voice-query. Information is gathered over time and with more users so that the system becomes more and more intuitive to use over time. New grammars are added as the system is deployed to additional languages because different languages can have different ways of misspeaking and making corrections.

### BRIEF DESCRIPTION OF THE DRAWINGS

Embodiments are illustrated by way of example, and not by way of limitation, in the figures of the accompanying drawings in which like reference numerals refer to similar elements.

FIG. 1 is a simplified block diagram of an apparatus for interpreting user utterances according to an embodiment.

FIG. 2 is a block diagram of the automatic speech recognition of FIG. 1 according to an embodiment.

FIG. 3 is a process flow diagram of interpreting user utterances according to an embodiment.

FIG. 4 is a block diagram of a computing device incorporating misspeak resolution according to an embodiment.

### DETAILED DESCRIPTION

As described herein, misspeaking, corrections and disfluency may alternatively be resolved using a sequence of classifiers. In some examples, three classifiers are used; intent detection; property recognition; and property selection. More or fewer classifiers may be used to suit different applications. A data driven machine learning approach may be used to train all of the classifiers.

Rather than parse voice queries using a grammar, temporal features may be used to distinguish between properties and revised properties in user utterances, such as commands and voice queries. As described herein a statistical sequence labeling method may be combined with a stack. The stack may be filled using statistical and linguistic knowledge at run-time. The stack may then be evaluated using a machine learning method to determine the real user intent. This technique is robust and can deal with self-corrections as well as speech disfluencies.

Consider an example voice query or command as follows: “set temperature to 80, ah, no 85 degrees, that is better than 80, please”. While this is polite it is not clear which temperature is desired. In other words, there are multiple properties “80,” “85,” and then again “80.” Given the confusion between these properties, the confusion of such a muddled request could be resolved by requiring an explicit disambiguation step from the user, in other words, by asking the user for clarification.

As described herein a data driven approach may be used instead. A pre-defined rule may be used such as “take the second parameter given in the explanation.” This corresponds to the statistical sequence labeling method. This is combined with a stack, in this case some user-data or text corpora. The model that is learned using a machine learning method uses temporal features, e.g. property_t1=“80”, property_t2=“85”, property_t3=“80”. During semantic analysis, the temporal features (t1, t2, t3) are taken into account together with the word sequence to understand the true user intent. Here, the system will choose “85” and set the temperature to “85.” The user experience is therefore that this muddled and confused statement is understood and the request is obeyed. This is much better than asking the user to repeat the statement or than the system resolving the confusion inaccurately. Users make many different such confused statements and resolving them requires a huge number of grammars and rules. Even so, a new kind of user mistake is always possible.

In testing, the accuracy of the system described herein is much higher with less investment than with grammar and rules-based systems. Some conventional grammar and rules approaches provide about a 20% error. The errors correspond to wrongly interpreted sentences. With the approach described herein there may be only a 5% error corresponding to far fewer wrongly interpreted sentences. Such a large improvement is directly apparent to the user and significantly enhances the user experience.

These great results are obtained in part by using temporal features to distinguish between properties and then revising the properties in the voice queries. This approach will be described in the context of the earlier example. A user makes the following utterance. “set temperature to 80, ah, no 85 degrees, that is better than 80 please.” Such an utterance has been referred to as a user query, a voice command, or speech input. The nature of the utterance will depend on the user intent and the abilities of the system that is listening. While, a command is discussed here, similar mistakes may be made in a query. A similar approach may be used for an utterance that is a query, not a command e.g. “what was the score of yesterday's Falcons game, ah, no the Ravens, the Falcons didn't play yesterday?” In addition, many other ambiguous and confusing utterances may be made.

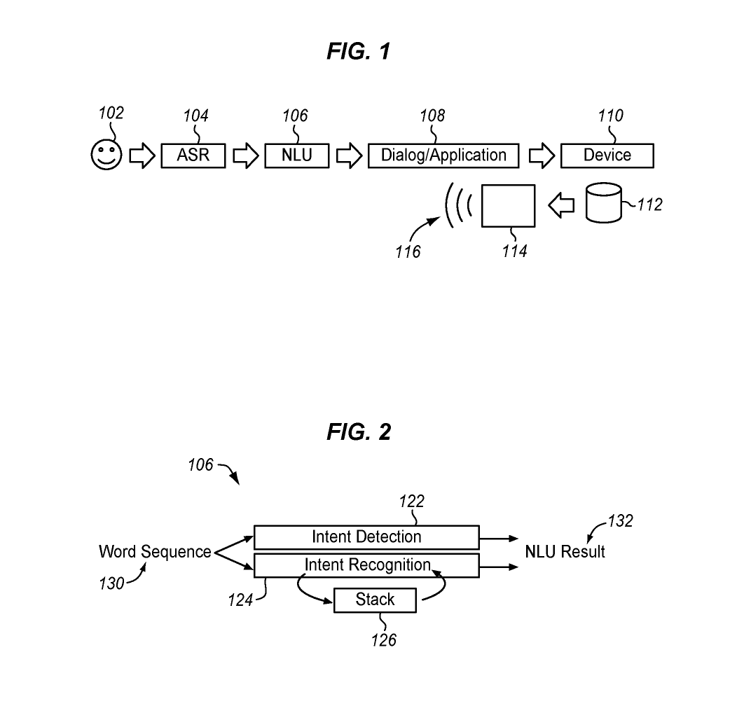

FIG. 1 is a simplified block diagram of an apparatus for interpreting user utterances. To begin, a user 102 makes a request, command, query, or other utterance. The voiced audio signal is analyzed by an automatic speech recognizer (ASR) 104. The ASR receives the analog audio of the user utterance through a microphone or electromagnetic waveform, digitizes it, and translates the audio signal into a sequence of words. In some embodiments, the system may receive a text string or phoneme sequence directly from the user. In other words, the user uses a smartphone, keyboard, or other text entry device to provide a text sequence to the ASR. A typed sequence may have the same types of errors as the spoken utterance. Additional errors are unique to the particular type of user interface. Spoken utterances may have mispronunciations and confused homophones. Typed sequence may have typographical errors. This sequence is analyzed by a Natural Language Understanding (NLU) module 106. The result of the NLU is a structured semantic representation which is used by a Dialogue or Application 108, e.g. to control an external device 110, to request data from an internal or external data store 112 or for any other purpose. The data store may then provide the information to a presentation device 114 which then presents the requested information 116 to the user.

This general diagram may relate to a single device that performs all functions or to several devices. In some embodiments, the user understanding components 104, 106, 108 are incorporated into the external device 110. The presentation system 114, whether a display, projector, transmitter, speaker, or some combination may also be part of this device. In other embodiments, the user understanding components are part of a single device that then issues commands to the external device or actuator, such as a thermostat or motor, or to multiple external devices. In this example, the devices may be window shades, lamps, door locks, cameras and other household items. The external device executes the command by adjusting a thermostat setting, lowering shades, lighting lamps, etc. The external device may or may not have a capability of understanding commands, but is able to execute commands received from the dialog/application module.

There may also be multiple iterations of the user understanding components so that utterances may be received throughout an area. These may then all connect to a network of other external devices so that the temperature can be adjusted from different parts of the house even out of the audio range of the thermostat. In other cases, there may be different external devices than those described here to suit different system installations. Similarly, the data store may be external and coupled through a network or the Internet to provide data and other services, including control of remote devices, and ordering goods and services.

FIG. 2 is an expanded view of the NLU module 106. As shown, the NLU module receives word sequences 130, typically in text form, from the ASR 104 and produces a result 132 as described below for use by the dialog/application 108. The NLU module includes three components, an intent detection module 122, a property detection module 124, and a stack 126. The property recognition module includes property detection, and property selection.

The intent detection module determines the intent of the user based on the voice query. In the above examples, the user intends to change a temperature setting or intends to find out a sports score.

User Intent may be determined in some embodiments as follows:

Intent=argmax_i=<intents>P(i|BOW)

where the intent, i, is determined to be the intent value at the maximum which is determined with the probability of the intent based on a Bag-of-Words (BOW) or other determiner. A variety of different word or phoneme configurations may be used. In some embodiments tf-idf weighted bag of word features, n-gram BOW features, or other word-embedding features are used

The intent detection may use a classifier based on a deep neural network. In each embodiment, the system is configured with some number of hidden layers with some number of neurons. In the examples herein these are applied to Bag-Of-Words features. The parameters of the neural network may be adapted to suit different input, outputs, and devices. Simpler devices, such as a thermostat are able to respond to fewer different commands than a television controller, for example, and so the user intent and possible utterances are limited.

The BOW features may be presented as vector representatives of word collections. For simplicity, a vector representation may be a binary one or it may be more complex with a vector dimension reduction applied. For more complexity a full vector may be used. Alternatively a Bayes classifier may be used, including a naive Bayes classifier.

The detected intent generated by the module 122 may be used in three ways: first, to select an intended function and application, e.g. the air-conditioning thermostat system function “set-temperature”, second, to select in-domain property recognition, and third to select selection models. Any one or more of these uses may be made to improve the overall accuracy.

The property recognition module 124 may be used to determine a property for each word of a given sentence. With properties, the earlier sentence may be characterized as follows:

“set”|unk “temperature”|unk “to”|unk “80”|temp “<ah>”|unk “no”|unk “85”|tmp “degrees”|unk “that”|unk “is”|unk “better”|unk “than”|unk “the”|unk “80”|tmp “please”|unk.

This notation presents each word of the sentence in order as follows: “<recognized word; ASR result>”|<label added by the sequence labler>, Where “unk” is a placeholder for an “unknown” classification and label. These unknown words or phonemes are ignored. The ability of the property recognition module may be adapted to recognize more or fewer words, depending on the application.

In other words, the module has recognized the numbers “80” and “85” as temperature values and mapped the sequence of each of the words. The properties of all of the other words are unknown. The system would be unable to perform a useful function without the contribution of the intent detection. With only this information, the system knows that the temperature of the air-conditioning thermostat should be set to 80 or 85.

The sentence above is represented with where e.g. “85” is a single word. In some embodiments the system may instead identify “85” as two words “eighty” and “five.” In such a case, the properties of both words may be identified as e.g. “eighty”|tmp “five”|tmp. These two words may then be linked together for selection purposes. Alternatively, the system may work with phonemes or some other speech unit.

The property recognition may be done, for example, by a recurrent neural network where a recurrent hidden layer with some number of neurons is evaluated for each word in the query, iteratively. This may be expressed as a probability based on a tag of the word and its history as follows:

P(tag|word,history)

for each word in the sentence where history contains all of the previous words.

In some embodiments, each word in the vocabulary is represented by a vector.

The vector dimension is smaller (e.g. 100 for the 100 neuron example) than the vocabulary size (as represented by a binary word marker). The dimension reduction may be treated as an input layer of a neural network and learned next to the other weights of the network using, for example, a decedent gradient learning methodology. Alternatively, a hidden Markov Model or Condition Random Field can be used.

In addition, each property may be validated given the NLU specification to ensure that a property can be correctly evaluated by subsequent modules, e.g. a property labeled with “tmp” could be specified as an integer number.

After intent detection and property detection, the third operation, property selection, (part of property recognition) selects the correct property given sentence features and a stack of previously recognized property hypotheses. The stack 126 that is applied to property selection includes semantic and temporal information. Property selection may be done using a deep neural network-based classifier. Such a classifier may be configured to select a correct property given a stack and the corresponding sentence features. The stack stores the sequence of labels which are not “unk” (unknown). The stack may be characterized in one example as follows:

Stack=[λ (word, label), word;label if label !=“unk” over <property recognition result>] [−1::][1:3]

In this characterization, the stack has a maximal size, e.g. |stack|=3. The stack may be sequentially ordered so that the most recent property is always on the top of the stack, e.g. stack=[“80”|tmp; “85”|tmp; “80”|tmp]. Sentence features may be taken, e.g., from the Bag-Of-Word (BOW) features. Using this same word vector representation of (1)/(2), the classifier may be configured to compute:

T=argmax_t_P(t|stack,BOW)

where t with 1<t<|stack| gives the position within the stack with the correct property; t_1=80, t_2=85, t_3=80. In this example, the correct selection is T=2 and the overall NLU result is “set-temperature”, “temperature=85”.

In many cases, the most recent entry T=1 is treated as a final NLU result (“set temperature to 80, no 85 degrees”; stack=[“85”|tmp; “80”|tmp]) and passed to the dialog and/or application 108. Exceptions are sentences like the above-mentioned example “set temperature to 80<ah> no 85 degrees that is better than the 80 please” or “set temperature to 80 degrees, 75 is too cold for me”; stack=[“80”|tmp, “75”|tmp].

The described data driven approach uses a sequence of three classifiers to find the most likely user intent and intent-property of a voice query. This system is able to resolve many different kinds of self-corrections and other possible ways to provide multiple values for simple parameters like “temperature” in a single sentence without further user-clarifications. In most case, the user query can be resolved without any need for the user to have a dialog with the system.

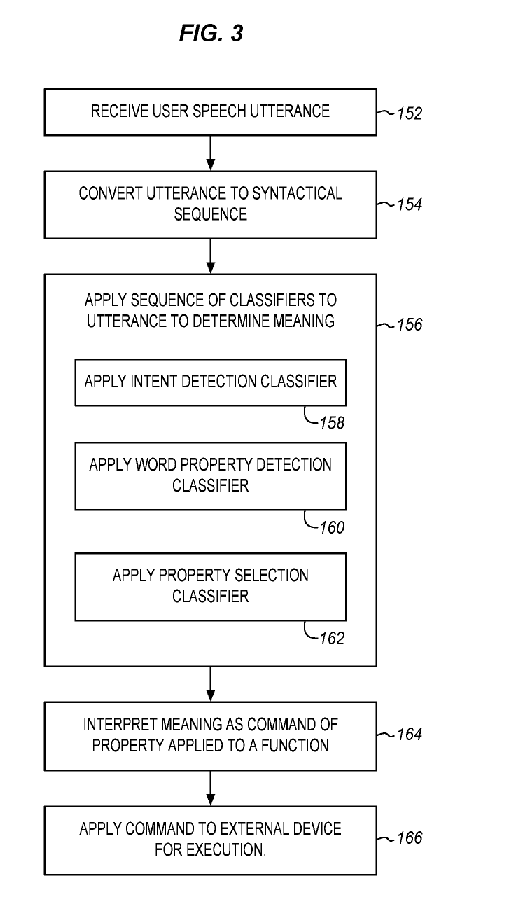

FIG. 3 is a process flow diagram to show some of the principles described herein. A system performs these operations using either local or remote resources to execute local or remote commands, searches, or queries. At 152 a system receives a user speech utterance. This is typically received analog audio from a microphone, but other types of input may be used. In the example, above, the user instructs a room thermostat to change the temperature setting, but any of a variety of other devices and utterances may be received at different devices.

At 154 a sequence of classifiers is applied to the utterance to determine the words that were spoken by the user. In the examples above, the utterance is converted into speech in an automatic speech recognition (ASR) module. In this case, the classifiers classify the words to determine the meaning of the text. Other syntactical representations may be used including phonemes.

At 162, having determined the meaning of the utterance, this meaning is interpreted as a command of a property that is to be applied to a function. In the thermostat example, the property is 85° applied to a temperature setting function. In the sports score example, the property is Ravens applied to a fetch game score function. The nature of the functions will depend upon the device being operated by the speech utterance. For a thermostat, there may be one function: set temperature. A more complex environmental system may have additional functions, such as fan speed, heater temperature, air conditioner temperature, humidifier, etc. Other devices may have more or fewer functions. Lamps, as an example, may have on and off, but may also have level and color control functions. Any one of these functions is identified in the utterance and a property is assigned to the function.

At 164 the property and function are converted to a command or instruction that is applied to external device, actuator, or data processing system for execution. This provides the result that was intended by the user in making the utterance.

The sequence of classifiers may take different forms. In this example, there are three classifiers: intent detection 158, word property 160, and property selection 162. The intent detection classifier determines an intended function, such as set the temperature. The other two classifiers determine a property, such as a temperature, to apply to the function. The word property detection classifier determines properties of words or phonemes in the syntactical sequence. The property selection classifier selects a property from among those of the classified words to apply to the intended function. In the thermostat example, once the function is selected, then only the words classified as temperature needed to be considered. The system then selected one of the two possible temperatures to set the system.

The syntactical sequence may take a variety of different forms, although a BOW with sequence information is mentioned above. The first classifier may operate to choose a word by applying a neural network to the words with properties that are related to the function. Once the relevant intention words are isolated, the first classifier may then apply probabilities of possible intents to the bag-of-words representation of the utterance and then select a most probable intent.

The second classifier may detect word properties using a vocabulary and a neural network. Each detected property may then be validated against a natural language understanding module to ensure that the corresponding word can be evaluated based on the property. Typically for each function, there is a limited class of possible properties and a limited class of possible words for those properties.

The third classifier may have a set of pre-defined rules for selecting an appropriate word for the intended property. Using the sequential information, the system may select the last word or the second of three words. The temporal features of the words may be used to distinguish between properties and then to revise the properties as understood from the original queries.

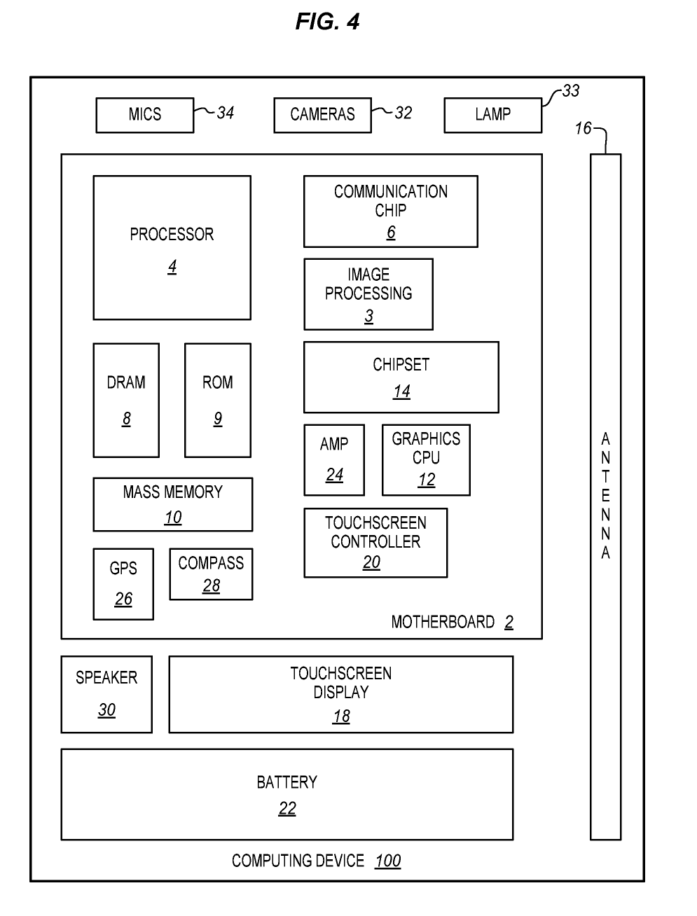

FIG. 4 is a block diagram of a computing device 100 in accordance with one implementation. The computing device 100 houses a system board 2. The board 2 may include a number of components, including but not limited to a processor 4 and at least one communication package 6. The communication package is coupled to one or more antennas 16. The processor 4 is physically and electrically coupled to the board 2.

Depending on its applications, computing device 100 may include other components that may or may not be physically and electrically coupled to the board 2. These other components include, but are not limited to, volatile memory (e.g., DRAM) 8, non-volatile memory (e.g., ROM) 9, flash memory (not shown), a graphics processor 12, a digital signal processor (not shown), a crypto processor (not shown), a chipset 14, an antenna 16, a display 18 such as a touchscreen display, a touchscreen controller 20, a battery 22, an audio codec (not shown), a video codec (not shown), a power amplifier 24, a global positioning system (GPS) device 26, a compass 28, an accelerometer (not shown), a gyroscope (not shown), a speaker 30, a camera 32, a lamp 33, a microphone array 34, and a mass storage device (such as a hard disk drive) 10, compact disk (CD) (not shown), digital versatile disk (DVD) (not shown), and so forth). These components may be connected to the system board 2, mounted to the system board, or combined with any of the other components.

The communication package 6 enables wireless and/or wired communications for the transfer of data to and from the computing device 100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 6 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 100 may include a plurality of communication packages 6. For instance, a first communication package 6 may be dedicated to shorter range wireless communications such as Wi-Fi and Bluetooth and a second communication package 6 may be dedicated to longer range wireless communications such as GPS, EDGE, GPRS, CDMA, WiMAX, LTE, Ev-DO, and others.

The ASR, NLU and dialog/application may be implemented in the processor or in an audio pipeline associated with the microphone. Models for the neural networks may be stored in the mass memory. Alternatively, the utterance may be sent to a remote location through the antenna and a command received back from the remote location. As mentioned previously, the misspeaking resolution may be located in the device to be controlled or in another device. Accordingly, the figure may represent a smart thermostat in which the communication chip also allows for control of heating or air conditioning systems. The figure may also represent a command unit that sends commands to the thermostat through the communications interface. Other variations are also possible as described elsewhere herein.

In various implementations, the computing device 100 may be eyewear, a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, a digital video recorder, wearables or drones. The computing device may be fixed, portable, or wearable. In further implementations, the computing device 100 may be any other electronic device that processes data.

Embodiments may be implemented as a part of one or more memory chips, controllers, CPUs (Central Processing Unit), microchips or integrated circuits interconnected using a motherboard, an application specific integrated circuit (ASIC), and/or a field programmable gate array (FPGA).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

The following examples pertain to further embodiments. The various features of the different embodiments may be variously combined with some features included and others excluded to suit a variety of different applications. Some embodiments pertain to a method of misspeak resolution for a man-machine interface. In one example a user speech utterance is received. A sequence of classifiers is applied to words of the utterance to determine a meaning of the utterance. The meaning in interpreted as a command and the command is applied to a device for execution. The classifiers may include a first classifier to determine an intended function that is a subject of the utterance, a second classifier to determine words with properties that are related to the intended function, and a third classifier to select a property to apply to the function.

In some embodiments applying a sequence of classifiers comprises applying a first classifier to determine an intended function that is a subject of the utterance and then applying a second classifier to determine words with properties that are related to the intended function.

Further embodiments include choosing a word to apply to the intended function by applying a neural network to the words with properties that are related to the function to choose a word.

In some embodiments the words with properties are structured as a bag of words with sequence information.

In some embodiments bag of words features are presented as vector representatives of word collections.

Further embodiments include selecting a function and application using the intended function.

In some embodiments the sequence of classifiers comprise a user intent detection, followed by a word property detection, followed by a property selection made by applying the intent to words having appropriate properties.

In some embodiments the intent detection classifier determines an intent of the user by applying probabilities of possible intents to a bag-of-words representation of the utterance and selecting a most probable intent.

In some embodiments the word property detection classifier associates words of the utterance with properties represented by the words.

In some embodiments the word property detection classifier detects word properties using a vocabulary and a neural network.

In some embodiments the word property detection classifier validates each detected property against a natural language understanding module to ensure that the corresponding word can be evaluated based on the property.

Further embodiments include the classifiers of the sequence of classifiers using data driven machine learning.

Further embodiments include using temporal features of the words to distinguish between properties and then revising properties in the utterance.

In some embodiments applying a sequence of classifier comprises classifying at least a portion of the words, the method further comprising applying a pre-defined rule to words of the same classification.

In some embodiments the pre-defined rule is to use the last word of the same classification as the meaning.

Some embodiments pertain to an apparatus that includes an automatic speech recognition module to receive a user speech utterance and determine a sequence of words, a natural language understanding module to apply a sequence of classifiers to the words of the utterance to determine a meaning of the utterance, and an application module to interpret the meaning as a command and to apply the command to a device for execution.

In some embodiments the natural language understanding module comprises a neural network to determine properties of words of the utterance.

In some embodiments the natural language understanding module classifier associates words of the utterance with properties represented by the words using temporal features of the words to distinguish between properties.

Some embodiments pertain to a speech operated system that includes a microphone to receive a speech utterance from a user, an automatic speech recognition module to receive the speech utterance and determine a sequence of words, a natural language understanding module to apply a sequence of classifiers to the words of the utterance to determine a meaning of the utterance, an application module to interpret the meaning as a command, and an actuator to execute the command.

In some embodiments the sequence of classifiers comprise a first classifier to determine an intended function that is a subject of the utterance, a second classifier to determine words with properties that are related to the intended function, and a third classifier to select a property to apply to the function.

What is claimed is:

1. A method comprising:
receiving a user speech utterance;
applying a sequence of classifiers to words of the utterance to determine a meaning of the utterance;
interpreting the determined meaning as a command; and
applying the command to a device for execution.

2. The method of claim 1, wherein applying a sequence of classifiers comprises applying a first classifier to determine an intended function that is a subject of the utterance and then applying a second classifier to determine words with properties that are related to the intended function.

3. The method of claim 2, further comprising choosing a word to apply to the intended function by applying a neural network to the words with properties that are related to the function to choose a word.

4. The method of claim 3, wherein the words with properties are structured as a bag of words with sequence information.

5. The method of claim 4, wherein bag of words features are presented as vector representatives of word collections.

6. The method of claim 2, further comprising selecting a function and application using the intended function.

7. The method of claim 1, wherein the sequence of classifiers comprise a user intent detection, followed by a word property detection, followed by a property selection made by applying the intent to words having appropriate properties.

8. The method of claim 7, wherein the intent detection classifier determines an intent of the user by applying probabilities of possible intents to a bag-of-words representation of the utterance and selecting a most probable intent.

9. The method of claim 7, wherein the word property detection classifier associates words of the utterance with properties represented by the words.

10. The method of claim 9, wherein the word property detection classifier detects word properties using a vocabulary and a neural network.

11. The method of claim 9, wherein the word property detection classifier validates each detected property against a natural language understanding module to ensure that the corresponding word can be evaluated based on the property.

12. The method of claim 1, further comprising the classifiers of the sequence of classifiers using data driven machine learning.

13. The method of claim 1, further comprising using temporal features of the words to distinguish between properties and then revising properties in the utterance.

14. The method of claim 1, wherein applying a sequence of classifier comprises classifying at least a portion of the words, the method further comprising applying a pre-defined rule to words of the same classification.

15. The method of claim 1, wherein the pre-defined rule is to use the last word of the same classification as the meaning.

16. An apparatus comprising:
an automatic speech recognition module to receive a user speech utterance and determine a sequence of words;
a natural language understanding module to apply a sequence of classifiers to the words of the utterance to determine a meaning of the utterance; and
an application module to interpret the meaning as a command and to apply the command to a device for execution.

17. The apparatus of claim 17, wherein the natural language understanding module comprises a neural network to determine properties of words of the utterance.

18. The apparatus of claim 17, wherein the natural language understanding module classifier associates words of the utterance with properties represented by the words using temporal features of the words to distinguish between properties.

19. A speech operated system comprising:
a microphone to receive a speech utterance from a user;
an automatic speech recognition module to receive the speech utterance and determine a sequence of words;
a natural language understanding module to apply a sequence of classifiers to the words of the utterance to determine a meaning of the utterance;
an application module to interpret the meaning as a command; and
an actuator to execute the command.

20. The system of claim 19, wherein the sequence of classifiers comprise:
a first classifier to determine an intended function that is a subject of the utterance;
a second classifier to determine words with properties that are related to the intended function; and
a third classifier to select a property to apply to the function.
